(19) United States
(12) Patent Application Publication
(10) Pub. No.: US 2012/0070730 A1
(43) Pub. Date: Mar. 22, 2012

(54) NONAQUEOUS ELECTROLYTE AND NONAQUEOUS ELECTROLYTE BATTERY

(75) Inventors: Ichiro Yamada, Fukushima (JP); Tadahiko Kubota, Kanagawa (JP)

(73) Assignee: Sony Corporation, Tokyo (JP)

(21) Appl. No.: 13/231,490

(22) Filed: Sep. 13, 2011

(30) Foreign Application Priority Data
Sep. 22, 2010 (JP) P2010-211963

(51) Int. Cl. H01M 10/02

(52) U.S. Cl. 429/200; 429/188; 429/199

(57) ABSTRACT

A nonaqueous electrolyte includes: a solvent; an electrolyte salt; and an ether ester compound of the following formula (1):

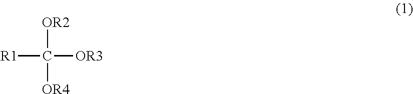

wherein R1 is a hydrogen group, an alkyl group, an aryl group, an alkoxy group, an ester group, or an acyl group, R2 to R4 are each independently an acyl group, a halogenated acyl group, an alkyl group, an aryl group, or a halogenated alkyl group, where at least one of R2 to R4 includes an acyl group or a halogenated acyl group.

### FIELD

The present disclosure relates to nonaqueous electrolytes and nonaqueous electrolyte batteries, specifically to nonaqueous electrolytes that contain an organic solvent and an electrolyte salt, and nonaqueous electrolyte batteries using such nonaqueous electrolytes.

### BACKGROUND

There is a strong demand for smaller, lighter, and longer-life portable electronic devices such as video cameras, cellular phones, and laptop personal computers, which have become pervasive over the last years. In this connection, batteries, particularly secondary batteries, which are light and capable of providing high energy density, have been developed as the power source of such portable electronic devices.

Particularly, secondary batteries (lithium ion secondary batteries) that take advantage of the storage and release of lithium for the charge and discharge reaction are very promising for their ability to provide higher energy density than lead batteries and nickel cadmium batteries.

Lithium ion secondary batteries include an electrolytic solution that contains a solvent and an electrolyte salt dissolved in the solvent. The solvent is commonly a mixed solvent of a high-dielectric-constant solvent and a low-viscosity solvent, the former being, for example, ethylene carbonate or propylene carbonate that easily solvates the electrolyte salt, and the latter being a solvent with excellent ion conductivity, for example, such as diethyl carbonate, dimethyl carbonate, and ethyl methyl carbonate.

The characteristics of lithium ion secondary batteries are greatly influenced by the type of nonaqueous electrolytic solution used, and thus a variety of nonaqueous electrolytic solutions containing various compounds have been proposed to further improve battery characteristics.

For example, JP-A-2006-86058 proposes a nonaqueous electrolytic solution in which reactive cyclic carbonate esters are added. Reactive cyclic carbonates such as halogenated cyclic carbonate esters (such as fluoroethylene carbonate), and unsaturated cyclic carbonate esters with carbon-carbon multiple bonds (such as vinylene carbonate) are added to the electrolytic solution to form a coating on a negative electrode surface. The coating suppresses the reaction or other interactions between the negative electrode active material and the electrolytic solution, and thus improves the charge and discharge efficiency.

The ever increasing energy density of nonaqueous electrolyte secondary batteries has necessitated an ever higher ion transfer speed between the positive and negative electrodes for improved battery charge and discharge characteristics. To this end, diffusive material transfer needs to be facilitated, for example, by increasing the ion conductivity of the electrolytic solution, or by lowering the viscosity of the electrolytic solution.

### SUMMARY

While the reactive cyclic carbonate esters described in the foregoing patent document can form a strong electrode coating, the coating increases the resistance of the electrode surface. As such, the battery characteristics are insufficient, particularly with regard to the discharge capacity in a large current discharge or in repeated charge and discharge.

Accordingly, there is a need for a nonaqueous electrolyte and a nonaqueous electrolyte battery with which the resistance increase due to the charge and discharge cycle can be suppressed to suppress the deterioration of battery characteristics.

An embodiment of the present disclosure is directed to a nonaqueous electrolyte that includes a solvent, an electrolyte salt, and an ether ester compound of the following formula (1):

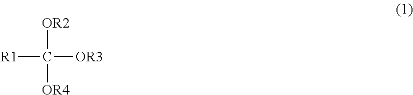

wherein R1 is a hydrogen group, an alkyl group, an aryl group, an alkoxy group, an ester group, or an acyl group, R2 to R4 are each independently an acyl group, a halogenated acyl group, an alkyl group, an aryl group, or a halogenated alkyl group, where at least one of R2 to R4 includes an acyl group or a halogenated acyl group.

Another embodiment of the present disclosure is directed to a nonaqueous electrolyte battery that includes a positive electrode, a negative electrode, and a nonaqueous electrolyte, wherein the nonaqueous electrolyte includes a solvent, an electrolyte salt, and an ether ester compound of the following formula (1):

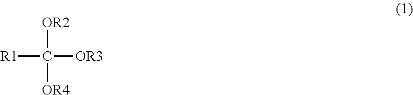

wherein R1 is a hydrogen group, an alkyl group, an aryl group, an alkoxy group, an ester group, or an acyl group, R2 to R4 are each independently an acyl group, a halogenated acyl group, an alkyl group, an aryl group, or a halogenated alkyl group, where at least one of R2 to R4 includes an acyl group or a halogenated acyl group.

According to the embodiments of the present disclosure, the nonaqueous electrolyte includes an ether ester compound of the formula (1). With the ether ester compound of the formula (1) contained in the nonaqueous electrolyte, a stable coating called an SEI (Solid Electrolyte Interface) is formed on electrode surfaces by charge and discharge. The SEI coating suppresses the decomposition of the nonaqueous electrolyte during the charge and discharge. This suppresses the ion conductivity from being lowered, and thus suppresses the capacity deterioration due to the charge and discharge cycle. Further, the maintained ion conductivity at the electrode surfaces in contact with the nonaqueous electrolyte is considered to form a low-resistance SEI. By suppressing the resistance increase due to the charge and discharge cycle, the deterioration of battery characteristics can be suppressed.

With the embodiments of the present disclosure, the resistance increase due to the charge and discharge cycle can be suppressed to suppress the deterioration of battery characteristics.

### BRIEF DESCRIPTION OF THE DRAWINGS

FIG. 1 is a cross sectional view illustrating an exemplary configuration of a nonaqueous electrolyte battery according to an embodiment of the present disclosure.

FIG. 2 is a partially enlarged cross sectional view of a wound electrode unit illustrated in FIG. 1.

FIG. 3 is an exploded perspective view illustrating an exemplary configuration of a nonaqueous electrolyte battery according to an embodiment of the present disclosure.

FIG. 4 is a cross sectional view of a wound electrode unit of FIG. 3 at I-I.

### DETAILED DESCRIPTION

The following describes embodiments of the present disclosure with reference to the accompanying drawings. Descriptions will be given in the following order.

1. First Embodiment (first example of nonaqueous electrolyte battery)
2. Second Embodiment (second example of nonaqueous electrolyte battery)
3. Third Embodiment (third example of nonaqueous electrolyte battery)
4. Other Embodiments (variations)

### 1. First Embodiment

### Configuration of Nonaqueous Electrolyte Battery

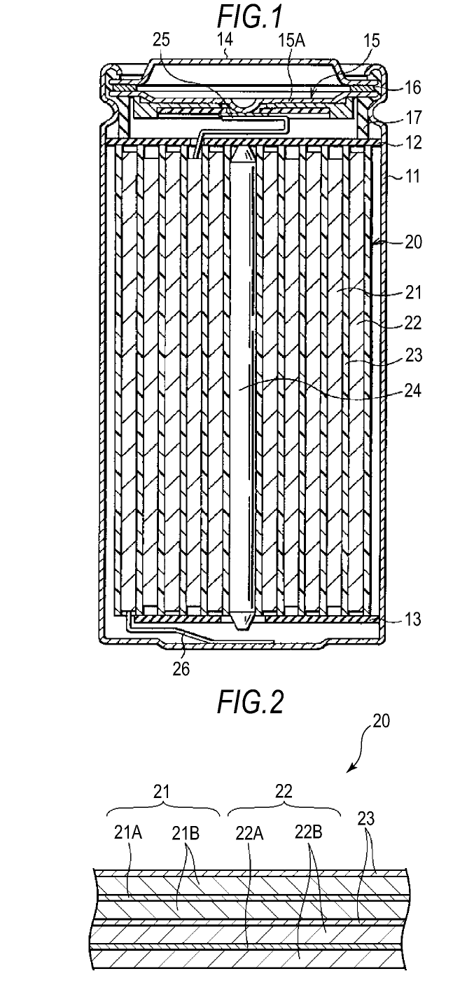

A nonaqueous electrolyte battery according to First Embodiment of the present disclosure is described below. FIG. 1 is a diagram representing a cross sectional configuration of the nonaqueous electrolyte battery according to First Embodiment of the present disclosure. FIG. 2 is a partial magnified view of a wound electrode unit 20 shown in FIG. 1. The nonaqueous electrolyte battery is a lithium ion secondary battery in which, for example, the negative electrode capacity is represented based on the storage and release of the electrode reaction substance lithium.

The nonaqueous electrolyte battery is structured to include primarily a substantially hollow cylindrical battery canister 11, a wound electrode unit 20 including a positive electrode 21 and a negative electrode 22 wound around with a separator 23 laminated in between, and a pair of insulating plates 12 and 13. The wound electrode unit 20 and the insulating plates 12 and 13 are housed inside the cylindrical battery canister 11. The battery structure using such a cylindrical battery canister 11 is called a cylindrical structure.

The battery canister 11 is made of, for example, nickel (Ni)-plated iron (Fe), and has a closed end and an open end. Inside the battery canister 11, the insulating plates 12 and 13 are disposed on the both sides of the wound electrode unit 20, perpendicularly to the rolled surface.

The battery canister 11 is sealed with a battery lid 14 fastened to the open end of the battery canister 11 by swaging via a gasket 17, together with a safety valve mechanism 15 and a heat-sensitive resistive element (PTC: Positive Temperature Coefficient) 16 provided inside the battery lid 14.

The battery lid 14 is formed using, for example, the same or similar materials used for the battery canister 11. The safety valve mechanism 15 is electrically connected to the battery lid 14 via the heat-sensitive resistive element 16, and cuts off the electrical connection between the battery lid 14 and the wound electrode unit 20 by the inversion of a disk plate 15A, when the pressure inside the battery reaches a certain level as a result of internal shorting or external heat.

The heat-sensitive resistive element 16 increases its resistance value under elevated temperatures, and restricts current to prevent abnormal heating due to overcurrent. The gasket 17 is formed using, for example, insulating material, and is asphalt-coated.

A center pin 24 is inserted at, for example, the center of the wound electrode unit 20. The positive electrode 21 of the wound electrode unit 20 is connected to a positive electrode lead 25 of, for example, aluminum (Al), and the negative electrode 22 is connected to a negative electrode lead 26 of, for example, nickel (Ni). The positive electrode lead 25 is electrically connected to the battery lid 14 by being welded to the safety valve mechanism 15. The negative electrode lead 26 is electrically connected to the battery canister 11 by being welded thereto.

### (Positive Electrode)

The positive electrode 21 is structured to include, for example, a positive electrode active material layer 21B provided on the both sides of a double-sided positive electrode collector 21A. The positive electrode active material layer 21B may be provided only on one side of the positive electrode collector 21A.

The positive electrode collector 21A is configured from metallic material, for example, such as aluminum, nickel, and stainless steel.

The positive electrode active material layer 21B includes positive electrode active material, which is one or more positive electrode materials capable of storing and releasing lithium. Other materials such as a binder and a conductive agent also may be contained, as required.

### (Positive Electrode Material)

Preferred examples of the positive electrode material that can store and release lithium include lithium-containing compounds, for their ability to provide high energy density. Examples of lithium-containing compounds include composite oxides that include lithium and transition metal elements; and phosphoric acid compounds that include lithium and transition metal elements. Of these, compounds including at least one transition metal element selected from cobalt, nickel, manganese, and iron are preferred for their ability to provide high voltage.

Examples of composite oxides that include lithium and transition metal elements include lithium cobalt composite oxide (LiₓCoO₂), lithium nickel composite oxide (LiₓNiO₂), lithium nickel cobalt composite oxide (LiₓNi_{1-z}Co_{z}O₂ (z<1)), lithium nickel cobalt manganese composite oxide (LiₓNi_{(1-v-w)}CoᵥMn_{w}O₂ (v+w<1)), and lithium manganese composite oxide (LiMn₂O₄) or lithium manganese nickel composite oxide (LiMn₂₋ₜNiₜO₄ (t<2)) of a spinel-type structure. Of these, cobalt-containing composite oxides are preferred for their ability to provide high capacity and excellent cycle characteristics. Examples of phosphoric acid compounds that include lithium and transition metal elements include lithium iron phosphate compounds (LiFePO₄), lithium iron manganese phosphate compounds (LiFe₁₋ᵤMnᵤPO₄ (u<1)), and LiₓFe_{1-y}M2_{y}PO₄ (where M2 represents at least one selected from manganese (Mn), nickel (Ni), cobalt (Co), zinc (Zn), and magnesium (Mg), x is a value that falls within the range 0.9≦x≦1.1).

From the standpoint of providing even higher electrode chargeability and cycle characteristics, composite particles may be used that are produced by coating the surface of the core particles of any of the foregoing lithium-containing compounds with fine particles of other lithium-containing compounds.

Other examples of the positive electrode material that can store and release lithium include: oxides such as titanium oxide, vanadium oxide, and manganese dioxide; disulfides such as titanium disulfide and molybdenum sulfide; chalcogenides such as niobium selenide; sulfur; and conductive polymers such as polyaniline and polythiophene. The positive electrode material that can store and release lithium may be other than these examples. Further, positive electrode materials such as those exemplified above may be used as a mixture of any combination of two or more.

### (Binder)

Examples of the binder include synthetic rubbers such as styrene-butadiene rubber, fluoro rubber, and ethylene propylene diene rubber; and polymer materials such as polyvinylidene fluoride. These may be used alone, or as a mixture of two or more.

### (Conductive Agent)

Examples of the conductive agent include carbon materials such as graphite, and carbon black. These may be used alone, or as a mixture of two or more.

### (Negative Electrode)

The negative electrode 22 is structured to include, for example, a negative electrode active material layer 22B provided on the both sides of a double-sided negative electrode collector 22A. The negative electrode active material layer 22B may be provided only on one side of the negative electrode collector 22A.

The negative electrode collector 22A is configured from metallic material, for example, such as copper, nickel, and stainless steel.

The negative electrode active material layer 22B includes a negative electrode active material, which may be one or more negative electrode materials capable of storing and releasing lithium. Other materials such as a binder and a conductive agent also may be contained, as required. The chargeable capacity of the negative electrode material that can store and release lithium is preferably greater than the discharge capacity of the positive electrode. Note that the specifics of the binder and the conductive agent are as described in conjunction with the positive electrode.

The negative electrode material that can store and release lithium may be, for example, carbon material. Examples of carbon material include easily graphitizable carbon, non-graphitizable carbon having a (002) plane distance of 0.37 nm or more, and graphite having a (002) plane distance of 0.34 nm or less. Specific examples include pyrolyzed carbons, cokes, glass-like carbon fibers, organic polymer compound calcined products, activated carbons, and carbon blacks. Cokes include pitch cokes, needle cokes, and petroleum cokes. The organic polymer compound calcined products refer to carbonized products obtained by calcining phenol resin, furan resin, or the like at appropriate temperatures. Carbon materials are preferred because they undergo a very few changes in crystal structure in the storage and release of lithium, and thus provide high energy density and excellent cycle characteristics, in addition to serving as conductive agents. The carbon material may be fibrous, spherical, granular, or scale-like in shape.

Aside from the carbon material, the negative electrode material that can store and release lithium may be, for example, material that, in addition to being capable of storing and releasing lithium, includes at least one of a metallic element and a semi-metallic element as the constituting element, because such materials also provide high energy density. Such negative electrode materials may include a metallic element or a semi-metallic element either alone or as an alloy or a compound, or may at least partially include one or more phases of these. As used herein, the “alloy” encompasses an alloy or two or more metallic elements, and an alloy of one or more metallic elements and one or more semi-metallic elements. Further, the “alloy” may include a non-metallic element. The composition may be a solid solution, a eutectic (eutectic mixture), or an intermetallic compound, or a mixture of two or more of these.

The metallic and semi-metallic elements are, for example, those capable of forming an alloy with lithium. Specific examples include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). At least one of silicon and tin is preferable, and silicon is more preferable, because these elements are highly capable of storing and releasing lithium, and can provide high energy density.

Examples of negative electrode material that includes at least one of silicon and tin include silicon, either alone or as an alloy or a compound, tin, either alone or as an alloy or a compound, and materials that at least partially include one or more phases of these.

Examples of silicon alloy include those including at least one non-silicon second constituting element selected from tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr). Examples of tin alloy include those including at least one non-tin (Sn) second constituting element selected from silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr).

Examples of tin compound and silicon compound include those containing, for example, oxygen (O) or carbon (C). The tin compound and the silicon compound may optionally include the second constituting elements exemplified above, in addition to tin (Sn) or silicon (Si).

Particularly preferred as the negative electrode material that includes at least one of silicon (Si) and tin (Sn) is, for example, a material that includes tin (Sn) as a first constituting element, and a second and a third constituting element in addition to first constituting element tin (Sn). The negative electrode material may be used together with the negative electrode materials exemplified above. The second constituting element is at least one selected from cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi), and silicon (Si). The third constituting element is at least one selected from boron (B), carbon (C), aluminum (Al), and phosphorus (P). Inclusion of the second and third elements improves cycle characteristics.

A CoSnC-containing material is particularly preferable that includes tin (Sn), cobalt (Co), and carbon (C) as the constituting elements, and in which the carbon (C) content ranges from 9.9 mass % to 29.7 mass %, inclusive, and in which the proportion of cobalt (Co) in the total of tin (Sn) and cobalt (Co) (Co/(Sn+Co)) ranges from 30 mass % to 70 mass %, inclusive. High energy density and excellent cycle characteristics can be obtained with these composition ranges.

The SnCoC-containing material may optionally include other constituting elements, as required. Preferred examples of other constituting elements include silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), and bismuth (Bi), which may be contained in combinations of two or more. Inclusion of these elements further improves capacity characteristics or cycle characteristics.

It is preferable that the SnCoC-containing material include a tin (Sn)-, cobalt (Co)-, and carbon (C)-containing phase, and that this phase have a low-crystalline or amorphous structure. Further, in the SnCoC-containing material, it is preferable that the constituting element carbon at least partially bind to the other constituting elements, namely, metallic elements or semi-metallic elements. Bonding of the carbon with other elements suppresses agglomeration or crystallization of tin (Sn) or other elements, which is considered to lower cycle characteristics.

The state of element binding can be measured by, for example, X-ray photoelectron spectroscopy (XPS). In XPS, the peak of the carbon 1s orbital (C1s) appears at 284.5 eV for graphite, when the device used is calibrated to provide a peak of the gold atom 4f orbital (Au4f) at 84.0 eV. The peak appears at 284.8 eV in surface-contaminated carbon. In contrast, when the carbon element charge density is high as in, for example, the carbon binding to a metallic element or a semi-metallic element, the C1s peak appears in a region below 284.5 eV. That is, when the C1s synthetic wave peak for SnCoC-containing material appears in a region below 284.5 eV, the carbon (C) contained in the SnCoC-containing material is at least partially binding to the other constituting elements, namely, the metallic element or the semi-metallic element.

Note that XPS uses, for example, a C1s peak for the calibration of the spectral energy axis. Generally, because the surface-contaminated carbon is present on the surface, the C1s peak of the surface-contaminated carbon is set to 284.8 eV, and used as the reference energy. In XPS, because the waveform of the C1s peak is obtained as the waveform that contains the peak of the surface-contaminated carbon and the peak of the carbon contained in the SnCoC-containing material, the peak of the surface-contaminated carbon and the peak of the carbon contained in the SnCoC-containing material are separated using, for example, commercially available software for analysis. In the waveform analysis, the position of the main peak on the lowest binding energy side is used as the reference energy (284.8 eV).

Other examples of the negative electrode material that can store and release lithium include metal oxides and polymer compounds that are capable of storing and releasing lithium. Examples of such metal oxides include iron oxide, ruthenium oxide, and molybdenum oxide. Examples of such polymer compounds include polyacetylene, polyaniline, and polypyrrole.

The negative electrode material that can store and release lithium may be other than these examples. Further, negative electrode materials such as those exemplified above may be used as a mixture of any combination of two or more.

The negative electrode active material layer 22B may be formed using, for example, any of a vapor-phase method, a liquid-phase method, a spray method, a calcining method, and coating, either individually or in combinations of two or more. When forming the negative electrode active material layer 22B using a vapor-phase method, a liquid-phase method, a spray method, or a calcining method, either individually or in combinations of two or more, it is preferable that an alloy be formed at least a portion of the interface between the negative electrode active material layer 22B and the negative electrode collector 22A. Specifically, it is preferable that the constituting elements of the negative electrode collector 22A diffuse into the negative electrode active material layer 22B at the interface, or the constituting elements of the negative electrode active material layer 22B diffuse into the negative electrode collector 22A at the interface. Further, these constituting elements preferably diffuse into the other layer between the negative electrode collector 22A and the negative electrode active material layer 22B. In this way, destruction caused by the expansion and contraction of the negative electrode active material layer 22B due to charge and discharge can be suppressed, and the electron conductivity between the negative electrode active material layer 22B and the negative electrode collector 22A can be improved.

The vapor-phase method may be, for example, a physical deposition method or a chemical deposition method, specifically, a vacuum deposition method, a sputter method, an ion plating method, a laser abrasion method, a chemical vapor deposition (CVD) method, or a plasma chemical vapor deposition method. Known techniques such as electroplating and non-electrolytic plating can be used as the liquid-phase method. The calcining method is a method in which, for example, a particulate negative electrode active material is mixed with other components such as a binder, dispersed in a solvent, and coated before it is subjected to a heat treatment at a temperature higher than the melting point of, for example, the binder. The calcining method also can be performed using known techniques, for example, such as an atmosphere calcining method, a reactive calcining method, and a hot-press calcining method.

### (Separator)

The separator 23 is provided to isolate the positive electrode 21 and the negative electrode 22 from each other, and allows for passage of lithium ions while preventing current shorting caused by contacting of the electrodes. The separator 23 is configured using, for example, a porous film of synthetic resin such as polytetrafluoroethylene, polypropylene, and polyethylene, or a ceramic porous film. The separator 23 may be a laminate of two or more of these porous films. The separator 23 is impregnated with an electrolytic solution.

### (Electrolytic Solution)

The electrolytic solution includes a solvent, an electrolyte salt, and an ether ester compound of formula (1):

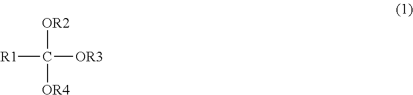

wherein R1 is a hydrogen group, an alkyl group, an aryl group, an alkoxy group, an ester group, or an acyl group, R2 to R4 are each independently an acyl group, a halogenated acyl group, an alkyl group, an aryl group or a halogenated alkyl group, where at least one of R2 to R4 includes an acyl group or a halogenated acyl group.

### (Solvent)

Examples of the solvent include carbonate esters (for example, compounds represented by the formula (A) R_{A}O—C(═O)—OR_{B}, where R_{A} and R_{B} each independently represent an alkyl group, and may be bonded to each other; such as ethylene carbonate (EC), propylene carbonate (PC), butylene carbonate, dimethyl carbonate, diethyl carbonate, ethyl methyl carbonate, and methylpropyl carbonate), γ-butyrolactone, γ-valerolactone, 1,2-dimethoxyethane, tetrahydrofuran, 2-methyltetrahydrofuran, tetrahydropyran, 1,3-dioxolan, 4-methyl-1,3-dioxolan, 1,3-dioxane, 1,4-dioxane, methyl acetate, ethyl acetate, methyl propionate, ethyl propionate, methyl butyrate, isomethyl butyrate, trimethyl methyl acetate, trimethyl ethyl acetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. These provide excellent capacity, excellent cycle characteristics, and excellent storage characteristics. These may be used either alone, or as a mixture of two or more.

Preferably, the solvent used includes at least one selected from ethylene carbonate, propylene carbonate, dimethyl carbonate, diethyl carbonate, and ethyl methyl carbonate. These are preferable for their ability to provide sufficient effects. In this case, it is preferable to use a high-viscosity (high-dielectric) solvent (for example, relative permitivity ∈≧30), for example, such as ethylene carbonate and propylene carbonate, as a mixture with a low-viscosity solvent (for example, viscosity≦1 mPa·s), for example, such as dimethyl carbonate, diethyl carbonate, and ethyl methyl carbonate. The use of such mixtures improves the dissociation of the electrolyte salt and ion mobility, and thus provides stronger effects.

### (Electrolyte Salt)

The electrolyte salt includes, for example, one or more light metal salts such as lithium salts. Examples of lithium salts include lithium hexafluorophosphate (LiPF₆), lithium tetrafluoroborate (LiBF₄), lithium perchloride (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). At least one selected from lithium hexafluorophosphate, lithium tetrafluoroborate, lithium perchloride, and lithium hexafluoroarsenate is preferable, of which lithium hexafluorophosphate is more preferable. These are preferable for their ability to lower the resistance of the electrolytic solution. Use of lithium hexafluorophosphate with lithium tetrafluoroborate is particularly preferred.

### (Ether Ester Compound)

The electrolytic solution includes the ether ester compound of formula (1). With the ether ester compound of formula (1) contained in the electrolytic solution, a stable SEI can be formed on the electrode surfaces in response to the charge and discharge in initial use. This suppresses the decomposition of the electrolytic solution in the charge and discharge, and thus suppresses the ion conductivity from being lowered, and maintains the battery characteristics. Further, containing the ether ester compound of formula (1) in the electrolytic solution forms a low-resistance SEI, and thus suppresses the resistance increase due to the charge and discharge cycle. As a result, the capacity decrease due to the charge and discharge cycle can be suppressed. Because the resistance-induced generation of Joule heat can be suppressed even during the large-current charge and discharge, the battery temperature does not easily increase, and the deterioration of the electrode active material and the electrolytic solution can be suppressed. The ether ester compound of formula (1) contained in the electrolytic solution is believed to maintain the ion conductivity at the electrode surfaces in contact with the electrolytic solution, and form a low-resistance SEI. It is considered that the ion conductivity at the electrode surfaces in contact with the electrolytic solution is maintained, and that a low-resistance SEI is formed because the ether ester compound of formula (1) similar in structure to the carbonate ester solvent is used.

An example of the ether ester compound of formula (1) is the ether ester compound represented by the following formula (2):

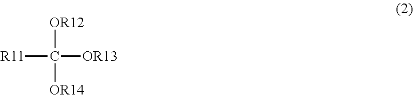

wherein R11 is a hydrogen group, an alkyl group, an aryl group, or an alkoxy group, where some of or all of the hydrogens may be substituted with halogens, R12 is an acyl group or a halogenated acyl group, R13 and R14 are each independently an alkyl group or an aryl group, where some of or all of the hydrogens may be substituted with halogens.

Specific examples of the ether ester compound of formula (2) include dimethoxymethyl acetate, trimethoxymethyl acetate, diethoxymethyl acetate, triethoxymethyl acetate, dipropoxymethyl acetate, tripropoxymethyl acetate, diphenoxymethyl acetate, triphenoxymethyl acetate, dimethoxy(methyl)methyl acetate, dimethoxy(phenyl)methyl acetate, dimethoxymethyl propionate, trimethoxymethyl propionate, diethoxymethyl propionate, triethoxymethyl propionate, dipropoxymethyl propionate, tripropoxymethyl propionate, diphenoxymethyl propionate, triphenoxymethyl propionate, dimethoxy(methyl)methyl propionate, dimethoxy(phenyl)methyl propionate, dimethoxymethyl butyrate, trimethoxymethyl butyrate, diethoxymethyl butyrate, triethoxymethyl butyrate, dipropoxymethyl butyrate, tripropoxymethyl butyrate, diphenoxymethyl butyrate, triphenoxymethyl butyrate, dimethoxy(methyl)methyl butyrate, dimethoxy(phenyl)methyl butyrate, dimethoxymethyl trifluoroacetate, trimethoxymethyl trifluoroacetate, diethoxymethyl trifluoroacetate, triethoxymethyl trifluoroacetate, dipropoxymethyl trifluoroacetate, tripropoxymethyl trifluoroacetate, diphenoxymethyl trifluoroacetate, triphenoxymethyl trifluoroacetate, dimethoxy(methyl)methyl trifluoroacetate, dimethoxy(phenyl)methyl trifluoroacetate, dimethoxymethyl difluoroacetate, trimethoxymethyl difluoroacetate, diethoxymethyl difluoroacetate, triethoxymethyl difluoroacetate, dipropoxymethyl difluoroacetate, tripropoxymethyl difluoroacetate, diphenoxymethyl difluoroacetate, triphenoxymethyl difluoroacetate, dimethoxy(methyl)methyl difluoroacetate, dimethoxy(phenyl)methyl difluoroacetate, dimethoxymethyl trichloroacetate, trimethoxymethyl trichloroacetate, diethoxymethyl trichloroacetate, triethoxymethyl trichloroacetate, dipropoxymethyl trichloroacetate, tripropoxymethyl trichloroacetate, diphenoxymethyl trichloroacetate, triphenoxymethyl trichloroacetate, dimethoxy(methyl)methyl trichloroacetate, dimethoxy(phenyl)methyl trichloroacetate, dimethoxymethyl benzoate, trimethoxymethyl benzoate, diethoxymethyl benzoate, triethoxymethyl benzoate, dipropoxymethyl benzoate, tripropoxymethyl benzoate, diphenoxymethyl benzoate, triphenoxymethyl benzoate, dimethoxy(methyl)methyl benzoate, and dimethoxy(phenyl)methyl benzoate.

Of these, particularly preferred are dimethoxymethyl acetate, diethoxymethyl acetate, triethoxymethyl acetate, dipropoxymethyl acetate, dimethoxy(methyl)methyl acetate, dimethoxymethyl propionate, diethoxymethyl propionate, dimethoxymethyl butyrate, diethoxymethyl butyrate, dimethoxymethyl trifluoroacetate, diethoxymethyl trifluoroacetate, triethoxymethyl trifluoroacetate, dimethoxymethyl difluoroacetate, diethoxymethyl difluoroacetate, dimethoxymethyl trichloroacetate, diethoxymethyl trichloroacetate, triethoxymethyl trichloroacetate, and dimethoxymethyl benzoate, because these are readily available, and can provide strong effects. These ether ester compounds may be used as a mixture of two or more.

The content of the ether ester compound of formula (1) is preferably from 0.05 mass % to 5 mass %, more preferably from 0.1 mass % to 3 mass % with respect to the electrolytic solution. With these content ranges, a sufficient SEI can be formed for the electrode surfaces, and the battery characteristics can be improved most effectively.

### (Halogenated Cyclic Carbonate Ester, Unsaturated Cyclic Carbonate Ester)

Preferably, the electrolytic solution contains cyclic carbonate esters of formulae (3) and (4), in addition to the ether ester compound of formula (1). The ether ester compound of formula (1) is reactive to the negative electrode, and, when added in excess or used alone, tends to cause gas production and lower the capacity as with the case of other carbonate ester solvents. The reaction of the ether ester compound of formula (1) with the negative electrode can be suppressed by containing the cyclic carbonate esters of formulae (3) and (4), and superior effects can be obtained.

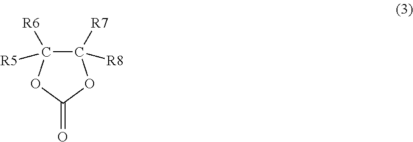

In the formula, R5 to R8 are each independently a hydrogen group, a halogen group, a vinyl group, an alkyl group, or a halogenated alkyl group, where at least one of R5 to R8 is a halogen group, a vinyl group, or a halogenated alkyl group.

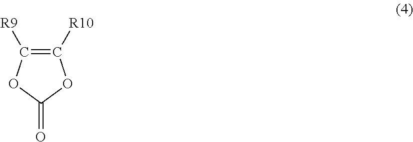

In the formula, R9 and R10 are each independently a hydrogen group, a halogen group, an alkyl group, or a halogenated alkyl group.

Examples of the cyclic carbonate esters represented by formulae (3) and (4) include the halogenated cyclic carbonate ester of formula (5), and the unsaturated cyclic carbonate ester of formula (6).

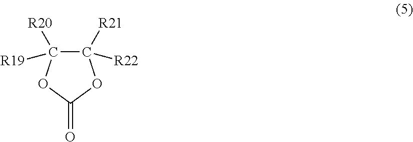

In the formula, R19 to R22 are each independently a hydrogen group, a halogen group, an alkyl group, or a halogenated alkyl group, where at least one of R19 to R22 is a halogen group or a halogenated alkyl group.

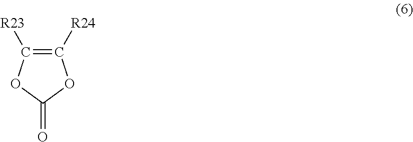

In the formula, R23 and R24 are each independently a hydrogen group or an alkyl group.

Examples of the halogenated cyclic carbonate ester of formula (5) include 4-fluoro-1,3-dioxolan-2-one, 4-chloro-1,3-dioxolan-2-one, 4,5-difluoro-1,3-dioxolan-2-one, tetrafluoro-1,3-dioxolan-2-one, 4-chloro-5-fluoro-1,3-dioxolan-2-one, 4,5-dichloro-1,3-oxolan-2-one, tetrachloro-1,3-dioxolan-2-one, 4,5-bistrifluoromethyl-1,3-dioxolan-2-one, 4-trifluoromethyl-1,3-dioxolan-2-one, 4,5-difluoro-4,5-dimethyl-1,3-dioxolan-2-one, 4,4-difluoro-5-methyl-1,3-dioxolan-2-one, 4-ethyl-5,5-difluoro-1,3-dioxolan-2-one, 4-fluoro-5-trifluoromethyl-1,3-dioxolan-2-one, 4-methyl-5-trifluoromethyl-1,3-dioxolan-2-one, 4-fluoro-4,5-dimethyl-1,3-dioxolan-2-one, 5-(1,1-difluoroethyl)-4,4-difluoro-1,3-dioxolan-2-one, 4,5-dichloro-4,5-dimethyl-1,3-dioxolan-2-one, 4-ethyl-5-fluoro-1,3-dioxolan-2-one, 4-ethyl-4,5-difluoro-1,3-dioxolan-2-one, 4-ethyl-4,5,5-trifluoro-1,3-dioxolan-2-one, and 4-fluoro-4-methyl-1,3-dioxolan-2-one. These may be used alone, or as a mixture of two or more. Of these, 4-fluoro-1,3-dioxolan-2-one and 4,5-difluoro-1,3-dioxolan-2-one are preferred, because of their availability and the ability to provide strong effects.

Examples of the unsaturated cyclic carbonate ester of formula (6) include vinylene carbonate(1,3-dioxol-2-one), methylvinylene carbonate(4-methyl-1,3-dioxol-2-one), ethylvinylene carbonate(4-ethyl-1,3-dioxol-2-one), 4,5-dimethyl-1,3-dioxol-2-one, and 4,5-diethyl-1,3-dioxol-2-one. These may be used alone, or as a mixture of two or more. Of these, vinylene carbonate is preferred because of its availability and the ability to provide strong effects. Some of the hydrogens in the unsaturated cyclic carbonate ester of formula (6) may be substituted with fluorine. Examples of such compounds include 4-fluoro-1,3-dioxol-2-one, and 4-trifluoromethyl-1,3-dioxol-2-one.

Preferably, the electrolytic solution contains a halogenated ether ester compound of formula (7)—a halogen-containing form of the ether ester compound of formula (1)—together with the halogenated cyclic carbonate ester of formula (5). This is preferable because, when the electrolytic solution contains the halogenated cyclic carbonate ester of formula (5), the use of the halogenated ether ester compound of formula (7) of a more similar structure is considered to maintain the ion conductivity of the electrode surfaces in contact with the electrolytic solution, and to form an SEI of an even lower resistance.

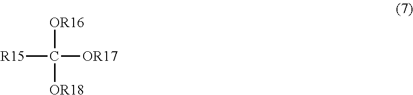

In the formula, R15 is a hydrogen group, an alkyl group, an aryl group, an alkoxy group, an ester group, or an acyl group. R16 to R18 are each independently an acyl group, a halogenated acyl group, an alkyl group, an aryl group, or a halogenated alkyl group, where at least one of R16 to R18 includes an acyl group or a halogenated acyl group, and where at least one of R16 to R18 includes a halogenated acyl group or a halogenated alkyl group.

### (Producing Method of Nonaqueous Electrolyte Battery)

The nonaqueous electrolyte battery can be produced as follows.

### (Production of Positive Electrode)

The fabrication begins with the positive electrode 21. For example, the positive electrode material, the binder, and the conductive agent are mixed to obtain a positive electrode mixture, which is then dispersed in an organic solvent, and formed into a paste positive electrode mixture slurry. The positive electrode mixture slurry is then evenly coated over the both surfaces of the positive electrode collector 21A using, for example, a doctor blade or a bar coater. After drying, the coating is compression molded using, for example, a roller press machine under optionally applied heat, and the positive electrode active material layer 21B is formed. The compression molding may be repeated multiple times.

### (Production of Negative Electrode)

The negative electrode 22 is fabricated next. For example, the negative electrode material, the binder, and, optionally, the conductive agent are mixed to obtain a negative electrode mixture, which is then dispersed in an organic solvent, and formed into a paste negative electrode mixture slurry. The negative electrode mixture slurry is evenly coated over the both surfaces of the negative electrode collector 22A using, for example, a doctor blade or a bar coater. After drying, the coating is compression molded using, for example, a roller press machine under optionally applied heat, and the negative electrode active material layer 22B is formed.

The positive electrode lead 25 and the negative electrode lead 26 are attached to the positive electrode collector 21A and to the negative electrode collector 22A, respectively, by, for example, welding. The positive electrode 21 and the negative electrode 22 are then wound around via the separator 23, and the positive electrode lead 25 and the negative electrode lead 26 are welded at the front end to the safety valve mechanism 15 and to the battery canister 11, respectively. The roll of the positive electrode 21 and the negative electrode 22 is then sandwiched between the insulating plates 12 and 13, and housed inside the battery canister 11. With the positive electrode 21 and the negative electrode 22 housed inside the battery canister 11, the electrolytic solution is injected into the battery canister 11, and the separator 23 is impregnated with the electrolytic solution. The battery lid 14, the safety valve mechanism 15, and the heat-sensitive resistive element 16 are then fastened to the open end of the battery canister 11 by swaging via the gasket 17. As a result, the nonaqueous electrolyte battery shown in FIGS. 1 and 2 is obtained.

The nonaqueous electrolyte battery according to First Embodiment of the present disclosure contains the ether ester compound of formula (1) in the electrolytic solution. In this way, a stable coating, called an SEI, is formed on the electrode surfaces in response to the charge and discharge. This helps prevent the decomposition of the nonaqueous electrolyte in the charge and discharge, and thus suppresses the ion conductivity from being lowered. As a result, the capacity deterioration due to the charge and discharge cycle can be suppressed. Further, the use of the ether ester compound of formula (1) is considered to maintain the ion conductivity of the electrode surfaces in contact with the nonaqueous electrolyte, and form a low-resistance SEI. The resistance increase due to the charge and discharge cycle can thus be suppressed. Because the resistance increase due to the charge and discharge cycle can be suppressed, there will be no large capacity decrease, and the resistance-induced Joule heat generation during the large-current charge and discharge can be suppressed. As a result, the battery temperature does not easily increase. The deterioration of the electrode active material and the electrolytic solution can thus be suppressed.

### 2. Second Embodiment

### Configuration of Nonaqueous Electrolyte Battery

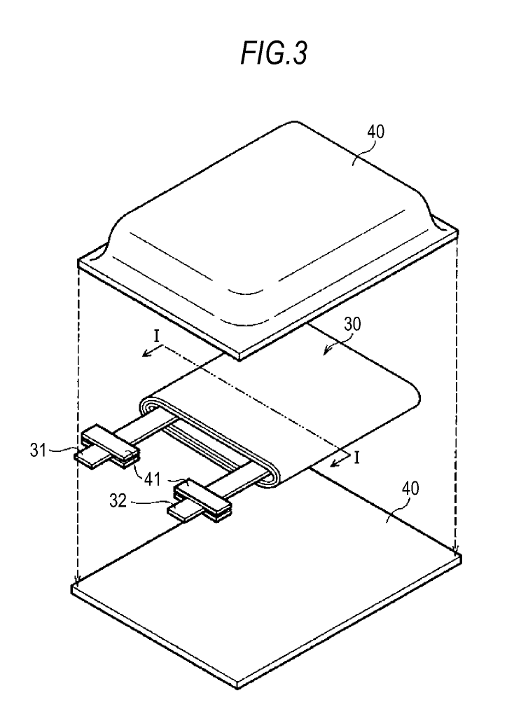

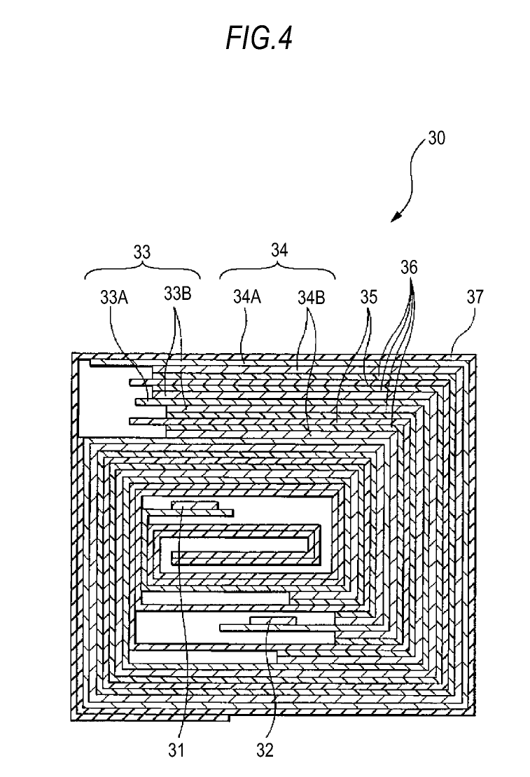

A nonaqueous electrolyte battery according to Second Embodiment of the present disclosure is described. FIG. 3 is an exploded perspective view representing a configuration of the nonaqueous electrolyte battery according to Second Embodiment of the present disclosure. FIG. 4 is a magnified cross sectional view of a wound electrode unit 30 of FIG. 3 at the line I-I.

The nonaqueous electrolyte battery is basically structured to include a film-like exterior member 40, and a wound electrode unit 30 housed in the exterior member 40 with a positive electrode lead 31 and a negative electrode lead 32 attached to the wound electrode unit 30. The battery structure using the film-like exterior member 40 is called a laminate film structure.

For example, the positive electrode lead 31 and the negative electrode lead 32 lead out in the same direction out of the exterior member 40. The positive electrode lead 31 is formed using, for example, metallic material such as aluminum. The negative electrode lead 32 is formed using, for example, metallic material such as copper, nickel, and stainless steel. These metallic materials are formed into, for example, a thin plate or a mesh.

The exterior member 40 is formed using, for example, an aluminum laminate film that includes a nylon film, an aluminum foil, and a polyethylene film laminated in this order. For example, the exterior member 40 is structured from a pair of rectangular aluminum laminate films fused or bonded with an adhesive at the peripheries with the polyethylene films facing the wound electrode unit 30.

An adhesive film 41 that prevents entry of external air is inserted between the exterior member 40 and the positive and negative electrode leads 31 and 32. The adhesive film 41 is configured using a material that has adhesion to the positive electrode lead 31 and the negative electrode lead 32. Examples of such material include polyolefin resins such as polyethylene, polypropylene, modified-polyethylene, and modified-polypropylene.

The exterior member 40 may be configured from laminate films of other laminate structures, instead of the aluminum laminate film, or from a polypropylene or other polymer films, or metal films.

FIG. 4 is a cross section of the wound electrode unit 30 of FIG. 3, taken along the line I-I. The wound electrode unit 30 is a wound unit of a positive electrode 33 and a negative electrode 34 laminated via a separator 35 and an electrolyte 36. The outermost periphery of the wound electrode unit 30 is protected by a protective tape 37.

The positive electrode 33 is structured to include, for example, a positive electrode active material layer 33B on the both sides of a positive electrode collector 33A. The negative electrode 34 is structured to include, for example, a negative electrode active material layer 34B on the both sides of a negative electrode collector 34A. The negative electrode active material layer 34B is disposed facing the positive electrode active material layer 33B. The positive electrode collector 33A, the positive electrode active material layer 33B, the negative electrode collector 34A, the negative electrode active material layer 34B, and the separator 35 are configured in the same way as the positive electrode collector 21A, the positive electrode active material layer 21B, the negative electrode collector 22A, the negative electrode active material layer 22B, and the separator 23 of First Embodiment.

The electrolyte 36 is a so-called gel electrolyte, including the electrolytic solution of First Embodiment, and a polymer compound that retains the electrolytic solution. The gel electrolyte is preferable, because it provides high ion conductivity (for example, 1mS/cm or more at room temperature), and prevents leaking.

Materials that gel by absorbing the electrolytic solution can be used as the polymer compound. Examples include polyacrylonitrile, polyvinylidene fluoride, a copolymer of vinylidene fluoride and hexafluoropyrene, polytetrafluoroethylene, polyhexafluoropropylene, polyethylene oxide, polypropylene oxide, polyphosphazene, polysiloxane, polyvinyl acetate, polyvinyl alcohol, polymethylmethacrylate, polyacrylic acid, polymethacrylic acid, styrene-butadiene rubber, nitrile-butadiene rubber, polystyrene, and polycarbonate. These may be used either alone, or as a mixture of two or more. Of these, polyacrylonitrile, polyvinylidene fluoride, polyhexafluoropropylene, and polyethylene oxide are preferred because of electrochemical stability.

### (Producing Method of Nonaqueous Electrolyte Battery)

The nonaqueous electrolyte battery is produced using, for example, three producing methods (first to third producing methods), as follows.

### (First Producing Method)

In the first producing method, for example, the positive electrode active material layer 33B is first formed on the both sides of the positive electrode collector 33A to form the positive electrode 33, according to the procedure used to form the positive electrode 21 and the negative electrode 22 in First Embodiment. The negative electrode active material layer 34B is formed on the both sides of the negative electrode collector 34A to form the negative electrode 34.

A separately prepared precursor solution containing the electrolytic solution, the polymer compound, and the solvent is coated over the positive electrode 33 and the negative electrode 34, and the solvent is evaporated to form the gel electrolyte 36. Then, the positive electrode lead 31 and the negative electrode lead 32 are attached to the positive electrode collector 33A and the negative electrode collector 34A, respectively.

The positive electrode 33 and the negative electrode 34 with the electrolyte 36 are then laminated via the separator 35, and wound along the longitudinal direction. The protective tape 37 is then bonded to the outermost periphery to fabricate the wound electrode unit 30. Finally, the wound electrode unit 30 is placed between, for example, a pair of film-like exterior members 40, and sealed therein by bonding the exterior members 40 at the peripheries by, for example, heatfusion. The adhesive film 41 is inserted between the positive and negative electrode leads 31 and 32 and the exterior members 40. This completes the nonaqueous electrolyte battery.

### (Second Producing Method)

In the second producing method, firstly, the positive electrode lead 31 and the negative electrode lead 32 are attached to the positive electrode 33 and the negative electrode 34, respectively. The positive electrode 33 and the negative electrode 34 are then laminated and wound around with the separator 35 in between, and the protective tape 37 is bonded to the outermost periphery to obtain a wound unit as a precursor of the wound electrode unit 30.

The wound unit is then placed between a pair of film-like exterior members 40, which are then bonded by, for example, heatfusion at the peripheries, leaving one side open. As a result, the wound unit is housed inside the bag of the exterior member 40. Then, an electrolyte composition is prepared that includes the electrolytic solution, the raw material monomer of the polymer compound, a polymerization initiator, and optional materials such as a polymerization inhibitor, and the electrolyte composition is injected into the bag of the exterior member 40. The opening of the exterior member 40 is then sealed by, for example, heatfusion. Finally, the monomer is heat polymerized into the polymer compound, and the gel electrolyte 36 is formed. This completes the nonaqueous electrolyte battery.

### (Third Producing Method)

In the third producing method, a wound unit is formed and housed in the bag of the exterior member 40 in the same manner as in the second producing method, except that the polymer compound is coated on the both sides of the separator 35 in advance.

The polymer compound coated on the separator 35 may be, for example, a polymer that includes a vinylidene fluoride component, specifically, a homopolymer, a copolymer, or a multicomponent copolymer. Specific examples include polyvinylidene fluoride, binary copolymers that include vinylidene fluoride and hexafluoropropylene components, and ternary copolymers that include vinylidene fluoride, hexafluoropropylene, and chlorotrifluoroethylene components.

Note that the polymer compound may include one or more other polymer compounds, in addition to the polymer that includes a vinylidene fluoride component. Then, the electrolytic solution is prepared, and injected into the exterior member 40, and the opening of the exterior member 40 is sealed by, for example, heatfusion. Finally, the exterior member 40 is heated under applied load to contact the separator 35 with the positive electrode 33 and the negative electrode 34 via the polymer compound. As a result, the electrolytic solution impregnates the polymer compound, causing the polymer compound to gel and form the electrolyte 36. This completes the nonaqueous electrolyte battery.

### 3. Third Embodiment

A nonaqueous electrolyte battery according to Third Embodiment of the present disclosure is described below. The nonaqueous electrolyte battery of Third Embodiment is not different from the nonaqueous electrolyte battery of Second Embodiment except that the electrolytic solution is directly used instead of using the polymer compound to retain the electrolytic solution (instead of using the electrolyte 36). Accordingly, the following description primarily deals with differences from Second Embodiment.

### (Configuration of Nonaqueous Electrolyte Battery)

The nonaqueous electrolyte battery according to Third Embodiment of the present disclosure uses the electrolytic solution instead of the gel electrolyte 36. Thus, the wound electrode unit 30 does not include the electrolyte 36, and instead includes the electrolytic solution impregnating the separator 35.

### (Producing Method of Nonaqueous Electrolyte Battery)

The nonaqueous electrolyte battery can be produced, for example, as follows.

First, for example, the positive electrode active material, the binder, and the conductive agent are mixed to prepare a positive electrode mixture, which is then dispersed in a solvent such as N-methyl-2-pyrrolidone to obtain a positive electrode mixture slurry. The positive electrode mixture slurry is coated on the both sides, dried, and compression molded to form the positive electrode active material layer 33B and obtain the positive electrode 33. Thereafter, for example, the positive electrode lead 31 is attached to the positive electrode collector 33A, for example, by ultrasonic welding or spot welding.

For example, the negative electrode material and the binder are mixed to prepare a negative electrode mixture, which is then dispersed in a solvent such as N-methyl-2-pyrrolidone to obtain a negative electrode mixture slurry. The negative electrode mixture slurry is coated on the both sides of the negative electrode collector 34A, dried, and compression molded to form the negative electrode active material layer 34B and obtain the negative electrode 34. Thereafter, for example, the negative electrode lead 32 is attached to the negative electrode collector 34A, for example, by ultrasonic welding or spot welding.

The positive electrode 33 and the negative electrode 34 are wound around with the separator 35 in between, and installed in the exterior member 40. The electrolytic solution is then injected into the exterior member 40, and the exterior member 40 is sealed. As a result, the nonaqueous electrolyte battery shown in FIGS. 3 and 4 is obtained.

### EXAMPLES

Specific Examples of the present disclosure are described below. It should be noted that the present disclosure is not limited by the following Examples. For convenience of explanation, the following compounds will be referred to as compounds A to X.

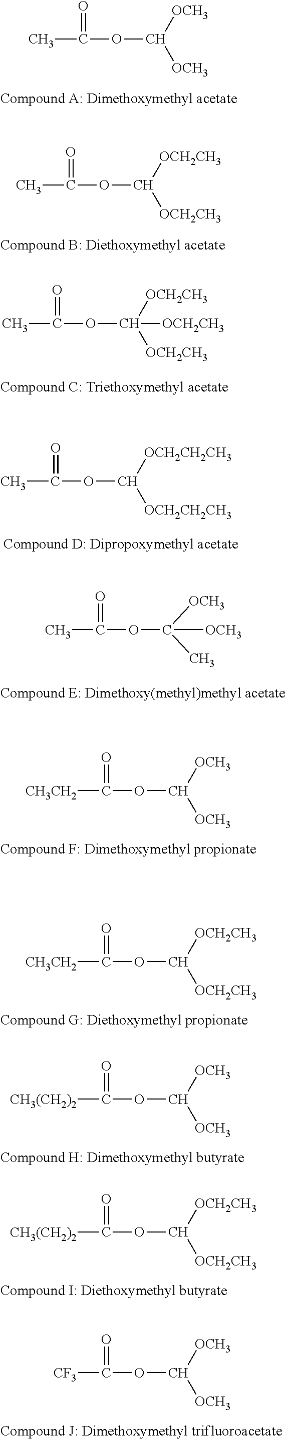

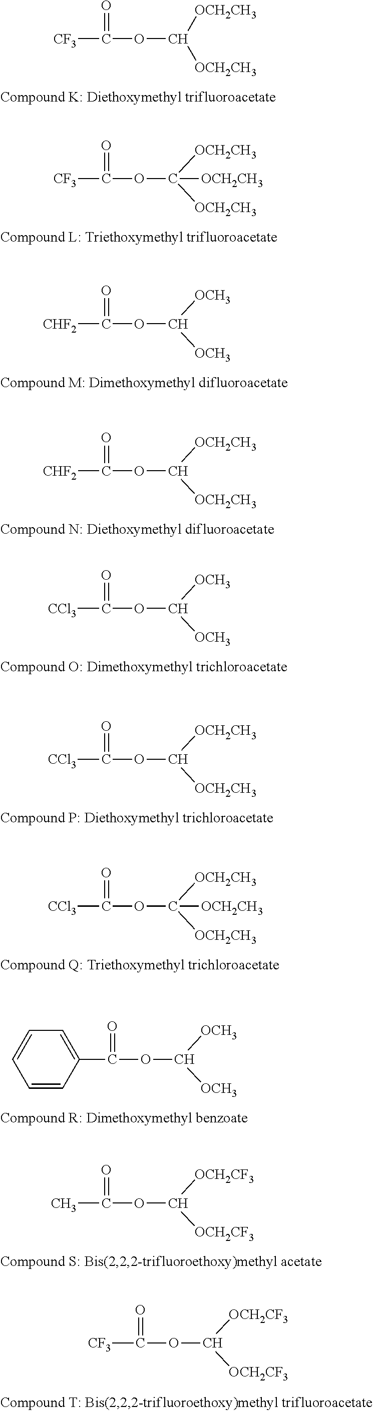

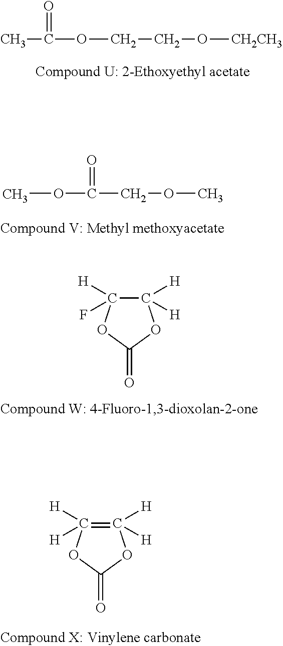

### Example 1-1

First, 91 parts by mass of the positive electrode active material lithium cobalt oxide, 6 parts by mass of the conductive agent graphite, and 3 parts by mass of the binder polyvinylidene fluoride were mixed, and N-methylpyrrolidone was added to obtain a positive electrode mixture slurry. The positive electrode mixture slurry was then evenly coated over the both surfaces of a 12-μm thick aluminum foil, dried, and compression molded with a roller press machine to obtain a positive electrode active material layer. Thereafter, an aluminum positive electrode lead was welded to one end of the positive electrode collector.

Separately, 97 parts by mass of the negative electrode active material artificial graphite powder, and 3 parts by mass of the binder polyvinylidene fluoride were mixed, and N-methylpyrrolidone was added to obtain a negative electrode mixture slurry. The negative electrode mixture slurry was then evenly coated over the both surfaces of a 15 μm thick copper foil (negative electrode collector), dried, and compression molded with a roller press machine to form a negative electrode active material layer. Thereafter, a nickel negative electrode lead was attached to one end of the negative electrode collector.

The positive electrode and the negative electrode were laminated via a separator provided in the form of a 25 μm-thick microporous polypropylene film. The laminate was wound multiple times in spirals, and the terminating end was fixed with an adhesive tape to obtain a wound electrode unit. After preparing a nickel-plated iron battery canister, the wound electrode unit was sandwiched between a pair of insulating plates. The negative electrode lead and the positive electrode lead were then welded to the battery canister and the safety valve mechanism, respectively, and the wound electrode unit was housed inside the battery canister. Then, the electrolytic solution was injected into the battery canister using a reduced pressure technique.

The electrolytic solution was prepared as follows. First, the electrolyte salt lithium hexafluorophosphate (LiPF₆) was dissolved in 1.2 mol/kg in a 3:7 (mass ratio) mixed solvent of ethylene carbonate (EC) and dimethyl carbonate (DMC). Then, compound A (ether ester compound of formula (1)) was added at a concentration of 0.025 mass % with respect to the total mass of the electrolytic solution to prepare the electrolytic solution. This completed the cylindrical nonaqueous electrolyte battery of Example 1-1.

### Example 1-2

A nonaqueous electrolyte battery was fabricated in the same manner as in Example 1-1, except that the concentration of the compound A used to prepare the electrolytic solution was changed to 0.05 mass %.

### Example 1-3

A nonaqueous electrolyte battery was fabricated in the same manner as in Example 1-1, except that the concentration of the compound A used to prepare the electrolytic solution was changed to 0.1 mass %.

### Example 1-4

A nonaqueous electrolyte battery was fabricated in the same manner as in Example 1-1, except that the concentration of the compound A used to prepare the electrolytic solution was changed to 0.5 mass %.

### Example 1-5

A nonaqueous electrolyte battery was fabricated in the same manner as in Example 1-1, except that the concentration of the compound A used to prepare the electrolytic solution was changed to 1 mass %.

### Example 1-6

A nonaqueous electrolyte battery was fabricated in the same manner as in Example 1-1, except that the concentration of the compound A used to prepare the electrolytic solution was changed to 3 mass %.

### Example 1-7

A nonaqueous electrolyte battery was fabricated in the same manner as in Example 1-1, except that the concentration of the compound A used to prepare the electrolytic solution was changed to 5 mass %.

### Example 1-8

A nonaqueous electrolyte battery was fabricated in the same manner as in Example 1-1, except that the concentration of the compound A used to prepare the electrolytic solution was changed to 7.5 mass %.

### Example 1-9

A nonaqueous electrolyte battery was fabricated in the same manner as in Example 1-1, except that the concentration of the compound A used to prepare the electrolytic solution was changed to 0.5 mass %, and that 1 mass % of compound W was added as a halogenated cyclic carbonate ester.

### Example 1-10

A nonaqueous electrolyte battery was fabricated in the same manner as in Example 1-1, except that the concentration of the compound A used to prepare the electrolytic solution was changed to 0.5 mass %, and that 1 mass % of compound X was added as an unsaturated cyclic carbonate ester.

### Example 1-11

A nonaqueous electrolyte battery was fabricated in the same manner as in Example 1-1, except that the concentration of the compound A used to prepare the electrolytic solution was changed to 1 mass %, and that 1 mass of compound W was added as a halogenated cyclic carbonate ester.

### Example 1-12

A nonaqueous electrolyte battery was fabricated in the same manner as in Example 1-1, except that the concentration of the compound A used to prepare the electrolytic solution was changed to 1 mass %, and that 1 mass of compound X was added as an unsaturated cyclic carbonate ester.

### Comparative Example 1-1

A nonaqueous electrolyte battery was fabricated in the same manner as in Example 1-1, except that the electrolytic solution was prepared without adding compound A.

### Comparative Example 1-2

A nonaqueous electrolyte battery was fabricated in the same manner as in Example 1-1, except that the electrolytic solution was prepared without adding compound A, and that 1 mass of compound W was added as a halogenated cyclic carbonate ester.

### Comparative Example 1-3

A nonaqueous electrolyte battery was fabricated in the same manner as in Example 1-1, except that the electrolytic solution was prepared without adding compound A, and that 2 mass of compound W was added as a halogenated cyclic carbonate ester.

### Comparative Example 1-4

A nonaqueous electrolyte battery was fabricated in the same manner as in Example 1-1, except that the electrolytic solution was prepared without adding compound A, and that 1 mass of compound X was added as an unsaturated cyclic carbonate ester.

### Comparative Example 1-5

A nonaqueous electrolyte battery was fabricated in the same manner as in Example 1-1, except that the electrolytic solution was prepared without adding compound A, and that 2 mass % of compound X was added as an unsaturated cyclic carbonate ester.

The nonaqueous electrolyte batteries of Examples 1-1 to 1-12 and Comparative Examples 1-1 to 1-5 were evaluated by initial capacity and cycle test, and charge load cycle test, as follows.

### (Initial Capacity and Cycle Test)

First, each battery was subjected to 2 cycles of charge and discharge under a current of 0.2 C in a 23° C. atmosphere, and the discharge capacity after the 2 cycles was measured. The charge and discharge cycle was repeated in 300 cycles in a 23° C. atmosphere, and the percentage remaining discharge capacity after 300 cycles relative to the discharge capacity after 2 cycles (hereinafter, “300 cycle percentage remaining discharge capacity”) was determined as follows.

Discharge capacity after 300 cycles/discharge capacity after 2 cycles)×100(%)

The batteries were charged and discharged under the following conditions. Each battery was charged to the upper limit voltage 4.2 V under a constant current of 0.2 C, and charged further to the current value of 0.05 C under the constant upper limit voltage. The battery was then discharged to the final voltage of 3.0 V under the constant current of 0.2 C. Note that “0.2 C” is the current value with which the theoretical capacity fully discharges in 5 hours.

### (Charge Load Cycle Test)

First, each battery was subjected to 2 cycles of charge and discharge under a current of 0.2 C in a 23° C. atmosphere, and the discharge capacity after the 2 cycles was measured. The charge and discharge cycle was repeated in 300 cycles in a 23° C. atmosphere, and the percentage remaining discharge capacity after 300 cycles relative to the discharge capacity after 2 cycles (hereinafter, “charge load cycle percentage remaining discharge capacity”) was determined as follows.

Discharge capacity after 300 cycles/discharge capacity after 2 cycles)×100(%)

The batteries were charged and discharged under the following conditions. Each battery was charged to the upper limit voltage 4.2 V under a constant current of 1.5 C, and charged further to the current value of 0.05 C under the constant upper limit voltage. The battery was then discharged to the final voltage of 3.0 V under the constant current of 0.2 C. Note that “1.5 C” is the current value with which the theoretical capacity fully discharges in 40 min.

The test results are presented in Table 1.

TABLE 1

| | | | | | 300 Cycle | Charge load cycle |
|---|---|---|---|---|---|---|
| | | | | | percentage | percentage |
| | | | Cyclic carbonate | | remaining | remaining |
| | Ether ester compound | | ester compound | | discharge | discharge |
| | Type | Mass % | Type | Mass % | capacity [%] | capacity [%] |
| Example 1-1 | Compound A | 0.025 | — | — | 78 | 68 |
| Example 1-2 | | 0.05 | | | 80 | 72 |
| Example 1-3 | | 0.1 | | | 80 | 75 |
| Example 1-4 | | 0.5 | | | 81 | 80 |
| Example 1-5 | | 1 | | | 82 | 80 |
| Example 1-6 | | 3 | | | 80 | 80 |
| Example 1-7 | | 5 | | | 80 | 78 |
| Example 1-8 | | 7.5 | | | 76 | 76 |
| Example 1-9 | Compound A | 0.5 | Compound W | 1 | 86 | 82 |
| Example 1-10 | | | Compound X | | 85 | 82 |
| Example 1-11 | | 1 | Compound W | | 86 | 84 |
| Example 1-12 | | | Compound X | | 86 | 83 |
| Comparative | — | — | — | — | 60 | 52 |
| Example 1-1 | | | | | | |
| Comparative | — | — | Compound W | 1 | 72 | 60 |
| Example 1-2 | | | | | | |
| Comparative | — | — | | 2 | 75 | 63 |
| Example 1-3 | | | | | | |
| Comparative | — | — | Compound X | 1 | 71 | 55 |
| Example 1-4 | | | | | | |
| Comparative | — | — | | 2 | 70 | 52 |
| Example 1-5 | | | | | | |

As can be seen in Table 1, Examples 1-1 to 1-12 containing the ether ester compound of formula (1) (compound A) in the electrolytic solution had higher 300 cycle percentage remaining discharge capacity and charge load cycle percentage remaining discharge capacity than Comparative Example 1-1. Specifically, the inclusion of the ether ester compound of formula (1) in the electrolytic solution suppressed the decomposition of the electrolytic solution and thus the cycle-induced resistance increase, improving the capacity deterioration due to the normal cycle and the charge load cycle. The suppressed battery internal resistance increase by the inclusion of the ether ester compound of formula (1) in the electrolytic solution means the maintained discharge capacity, and can suppress the battery temperature increase during the process of high-rate charging, making it possible to further suppress the deterioration of battery characteristics.

In Examples 1-1 to 1-8, the values of 300 cycle percentage remaining discharge capacity and charge load cycle percentage remaining discharge capacity were higher when the content of the ether ester compound of formula (1) was from 0.05 mass % to 5 mass %. The values of 300 cycle percentage remaining discharge capacity and charge load cycle percentage remaining discharge capacity were even higher in Examples 1-9 to 1-12 that contained the cyclic carbonate ester (compound W or X) in the electrolytic solution in addition to the ether ester compound of formula (1).

In Comparative Examples 1-2 to 1-5, the electrolytic solution contained the cyclic carbonate ester (compound W or X), but did not contain the ether ester compound of formula (1). The inclusion of the cyclic carbonate ester (compound W or X) in the electrolytic solution produced higher values of 300 cycle percentage remaining discharge capacity and charge load cycle percentage remaining discharge capacity than in Comparative Example 1-1. However, the extent of increase was not as great as in Examples (for example, Example 1-5) in which the ether ester compound of formula (1) was contained. Note that, as can be seen from Comparative Examples 1-4 and 1-5, increasing the content of the unsaturated cyclic carbonate ester (compound X) tended to lower the 300 cycle percentage remaining discharge capacity and the charge load cycle percentage remaining discharge capacity.

### Example 2-1

A nonaqueous electrolyte battery was fabricated in the same manner as in Example 1-5.

### Example 2-2

A nonaqueous electrolyte battery was fabricated in the same manner as in Example 2-1, except that compound B, not compound A, was added for the preparation of the electrolytic solution.

### Example 2-3

A nonaqueous electrolyte battery was fabricated in the same manner as in Example 2-1, except that compound C, not compound A, was added for the preparation of the electrolytic solution.

### Example 2-4

A nonaqueous electrolyte battery was fabricated in the same manner as in Example 2-1, except that compound D, not compound A, was added for the preparation of the electrolytic solution.

### Example 2-5

A nonaqueous electrolyte battery was fabricated in the same manner as in Example 2-1, except that compound E, not compound A, was added for the preparation of the electrolytic solution.

### Example 2-6

A nonaqueous electrolyte battery was fabricated in the same manner as in Example 2-1, except that compound F, not compound A, was added for the preparation of the electrolytic solution.

### Example 2-7

A nonaqueous electrolyte battery was fabricated in the same manner as in Example 2-1, except that compound G, not compound A, was added for the preparation of the electrolytic solution.

### Example 2-8

A nonaqueous electrolyte battery was fabricated in the same manner as in Example 2-1, except that compound H, not compound A, was added for the preparation of the electrolytic solution.

### Example 2-9

A nonaqueous electrolyte battery was fabricated in the same manner as in Example 2-1, except that compound I, not compound A, was added for the preparation of the electrolytic solution.

### Example 2-10

A nonaqueous electrolyte battery was fabricated in the same manner as in Example 2-1, except that compound J, not compound A, was added for the preparation of the electrolytic solution.

### Example 2-11

A nonaqueous electrolyte battery was fabricated in the same manner as in Example 2-1, except that compound K, not compound A, was added for the preparation of the electrolytic solution.

### Example 2-12

A nonaqueous electrolyte battery was fabricated in the same manner as in Example 2-1, except that compound L, not compound A, was added for the preparation of the electrolytic solution.

### Example 2-13

A nonaqueous electrolyte battery was fabricated in the same manner as in Example 2-1, except that compound M, not compound A, was added for the preparation of the electrolytic solution.

### Example 2-14

A nonaqueous electrolyte battery was fabricated in the same manner as in Example 2-1, except that compound N, not compound A, was added for the preparation of the electrolytic solution.

### Example 2-15

A nonaqueous electrolyte battery was fabricated in the same manner as in Example 2-1, except that compound O, not compound A, was added for the preparation of the electrolytic solution.

### Example 2-16

A nonaqueous electrolyte battery was fabricated in the same manner as in Example 2-1, except that compound P, not compound A, was added for the preparation of the electrolytic solution.

### Example 2-17

A nonaqueous electrolyte battery was fabricated in the same manner as in Example 2-1, except that compound Q, not compound A, was added for the preparation of the electrolytic solution.

### Example 2-18

A nonaqueous electrolyte battery was fabricated in the same manner as in Example 2-1, except that compound R, not compound A, was added for the preparation of the electrolytic solution.

### Example 2-19

A nonaqueous electrolyte battery was fabricated in the same manner as in Example 2-1, except that compound S, not compound A, was added for the preparation of the electrolytic solution.

### Example 2-20

A nonaqueous electrolyte battery was fabricated in the same manner as in Example 2-1, except that compound T, not compound A, was added for the preparation of the electrolytic solution.

### Examples 2-21 to 2-40

Nonaqueous electrolyte batteries were fabricated in the same manner as in Examples 2-1 to 2-20, except that compound W (halogenated cyclic carbonate ester) was also added for the preparation of the electrolytic solution.

### Examples 2-41 to 2-60

Nonaqueous electrolyte batteries were fabricated in the same manner as in Examples 2-1 to 2-20, except that compound X (unsaturated cyclic carbonate ester) was also added for the preparation of the electrolytic solution.

### Comparative Example 2-1

A nonaqueous electrolyte battery was fabricated in the same manner as in Example 2-1, except that compound U, not compound A, was added for the preparation of the electrolytic solution.

### Comparative Example 2-2

A nonaqueous electrolyte battery was fabricated in the same manner as in Example 2-1, except that compound V, not compound A, was added for the preparation of the electrolytic solution.

As in Example 1-1, the nonaqueous electrolyte batteries of Examples 2-1 to 2-60 were evaluated by initial capacity and cycle test, and charge load cycle test. The test results are presented in Table 2.

TABLE 2

| | | | | | 300 Cycle | Charge load cycle |
|---|---|---|---|---|---|---|
| | | | | | percentage | percentage |
| | | | Cyclic carbonate | | remaining | remaining |
| | Ether ester compound | | ester compound | | discharge | discharge |
| | Type | Mass % | Type | Mass % | capacity [%] | capacity [%] |
| Example 2-1 | Compound A | 1 | — | — | 82 | 80 |
| Example 2-2 | Compound B | | | | 83 | 81 |
| Example 2-3 | Compound C | | | | 82 | 81 |
| Example 2-4 | Compound D | | | | 81 | 79 |
| Example 2-5 | Compound E | | | | 81 | 78 |
| Example 2-6 | Compound F | | | | 80 | 78 |
| Example 2-7 | Compound G | | | | 80 | 77 |
| Example 2-8 | Compound H | | | | 81 | 78 |
| Example 2-9 | Compound I | | | | 78 | 76 |
| Example 2-10 | Compound J | | | | 83 | 81 |
| Example 2-11 | Compound K | | | | 83 | 82 |
| Example 2-12 | Compound L | | | | 83 | 81 |
| Example 2-13 | Compound M | | | | 81 | 80 |
| Example 2-14 | Compound N | | | | 82 | 80 |
| Example 2-15 | Compound O | | | | 77 | 75 |
| Example 2-16 | Compound P | | | | 78 | 75 |
| Example 2-17 | Compound Q | | | | 80 | 76 |
| Example 2-18 | Compound R | | | | 79 | 78 |
| Example 2-19 | Compound S | | | | 82 | 81 |
| Example 2-20 | Compound T | | | | 82 | 80 |
| Comparative | Compound U | 1 | — | — | 66 | 49 |
| Example 2-1 | | | | | | |
| Comparative | Compound V | | | | 62 | 48 |
| Example 2-2 | | | | | | |
| Example 2-21 | Compound A | 1 | Compound W | 1 | 86 | 84 |
| Example 2-22 | Compound B | | | | 86 | 85 |
| Example 2-23 | Compound C | | | | 85 | 84 |
| Example 2-24 | Compound D | | | | 85 | 83 |
| Example 2-25 | Compound E | | | | 84 | 82 |
| Example 2-26 | Compound F | | | | 83 | 81 |
| Example 2-27 | Compound G | | | | 82 | 80 |
| Example 2-28 | Compound H | | | | 83 | 80 |
| Example 2-29 | Compound I | | | | 81 | 78 |
| Example 2-30 | Compound J | | | | 85 | 84 |
| Example 2-31 | Compound K | | | | 85 | 84 |
| Example 2-32 | Compound L | | | | 86 | 84 |
| Example 2-33 | Compound M | | | | 84 | 82 |
| Example 2-34 | Compound N | | | | 84 | 81 |
| Example 2-35 | Compound O | | | | 79 | 76 |
| Example 2-36 | Compound P | | | | 80 | 77 |
| Example 2-37 | Compound Q | | | | 81 | 78 |
| Example 2-38 | Compound R | | | | 81 | 78 |
| Example 2-39 | Compound S | | | | 85 | 84 |
| Example 2-40 | Compound T | | | | 85 | 83 |
| Example 2-41 | Compound A | 1 | Compound X | 1 | 86 | 83 |
| Example 2-42 | Compound B | | | | 86 | 84 |
| Example 2-43 | Compound C | | | | 85 | 83 |
| Example 2-44 | Compound D | | | | 84 | 82 |
| Example 2-45 | Compound E | | | | 84 | 81 |
| Example 2-46 | Compound F | | | | 84 | 80 |
| Example 2-47 | Compound G | | | | 83 | 78 |
| Example 2-48 | Compound H | | | | 83 | 79 |
| Example 2-49 | Compound I | | | | 81 | 76 |
| Example 2-50 | Compound J | | | | 85 | 83 |
| Example 2-51 | Compound K | | | | 86 | 84 |
| Example 2-52 | Compound L | | | | 85 | 83 |
| Example 2-53 | Compound M | | | | 84 | 81 |
| Example 2-54 | Compound N | | | | 85 | 81 |
| Example 2-55 | Compound O | | | | 78 | 75 |
| Example 2-56 | Compound P | | | | 80 | 75 |
| Example 2-57 | Compound Q | | | | 80 | 76 |
| Example 2-58 | Compound R | | | | 81 | 77 |
| Example 2-59 | Compound S | | | | 85 | 83 |
| Example 2-60 | Compound T | | | | 84 | 82 |

As can be seen in Table 2, Examples 2-1 to 2-20 containing the ether ester compound of formula (1) (compounds A to T) in the electrolytic solution had higher 300 cycle percentage remaining discharge capacity and charge load cycle percentage remaining discharge capacity than Comparative Example 1-1. Specifically, the inclusion of the ether ester compound of formula (1) in the electrolytic solution suppressed the decomposition of the electrolytic solution and thus the cycle-induced resistance increase, improving the capacity deterioration due to the normal cycle and the charge load cycle.

In Examples 2-21 to 2-60, the electrolytic solution contained the cyclic carbonate ester (compound W or X), in addition to the ether ester compound of formula (1) (compounds A to T). This further suppressed the decrease of the 300 cycle percentage remaining discharge capacity and the charge load cycle percentage remaining capacity.

In contrast, Comparative Examples 2-1 and 2-2, containing compound U or V in the electrolytic solution instead of the ether ester compound of formula (1), failed to sufficiently suppress the decrease of the 300 cycle percentage remaining discharge capacity and the charge load cycle percentage remaining capacity. Compounds U and V, ether ester compounds of the structure containing both an ether group and an ester group, failed to improve the capacity deterioration due to the normal cycle and the charge load cycle. Specifically, it can be seen that ether ester compounds of a specific structure, such as the ether ester compound of formula (1), are particularly effective at improving the battery characteristics. The ether ester compound of formula (1) is structurally similar to the solvent (carbonate ester) of the electrolytic solution, and can therefore effectively improve the battery characteristics.

### Examples 3-1 to 3-40

The negative electrode was fabricated in the following manner. First, a negative electrode collector (15 μm thickness) was prepared from an electrolytic copper foil. Silicon was then deposited as negative electrode active material on the both surfaces of the negative electrode collector using an electron beam vapor deposition method to form a negative electrode active material layer. The deposition step was repeated 10 times to form the negative electrode active material layer of a structure including 10 layers of negative electrode active material particles. Here, the thickness (total thickness) of the negative electrode active material particles on one side of the negative electrode collector was 6 μm. The negative electrode so obtained was cut into a predetermined shape to obtain a negative electrode for cylindrical batteries. The thickness of the positive electrode active material layer was adjusted to prevent deposition of lithium metal on the negative electrode in the fully charged state. For the rest of the procedure, the procedure of Examples 2-1 to 2-40 was followed to fabricate nonaqueous electrolyte batteries.

### Comparative Example 3-1

A nonaqueous electrolyte battery was fabricated in the same manner as in Example 3-1, except that compound A was not added in the preparation of the electrolytic solution.

### Comparative Example 3-2

A nonaqueous electrolyte battery was fabricated in the same manner as in Example 3-21, except that compound A was not added in the preparation of the electrolytic solution.

As in Example 1-1, the nonaqueous electrolyte batteries of Examples 3-1 to 3-40 and Comparative Examples 3-1 and 3-2 were evaluated by initial capacity and cycle test, and charge load cycle test. The test results are presented in Table 3.

TABLE 3

| | | | | | 300 Cycle | Charge load cycle |
|---|---|---|---|---|---|---|
| | | | | | percentage | percentage |
| | | | Cyclic carbonate | | remaining | remaining |
| | Ether ester compound | | ester compound | | discharge | discharge |
| | Type | Mass % | Type | Mass % | capacity [%] | capacity [%] |
| Example 3-1 | Compound A | 1 | — | — | 65 | 58 |
| Example 3-2 | Compound B | | | | 65 | 60 |
| Example 3-3 | Compound C | | | | 64 | 61 |
| Example 3-4 | Compound D | | | | 63 | 58 |
| Example 3-5 | Compound E | | | | 63 | 58 |
| Example 3-6 | Compound F | | | | 62 | 57 |
| Example 3-7 | Compound G | | | | 62 | 56 |
| Example 3-8 | Compound H | | | | 62 | 58 |
| Example 3-9 | Compound I | | | | 59 | 57 |
| Example 3-10 | Compound J | | | | 66 | 61 |
| Example 3-11 | Compound K | | | | 67 | 61 |
| Example 3-12 | Compound L | | | | 66 | 62 |
| Example 3-13 | Compound M | | | | 65 | 60 |
| Example 3-14 | Compound N | | | | 65 | 61 |
| Example 3-15 | Compound O | | | | 57 | 54 |
| Example 3-16 | Compound P | | | | 57 | 55 |
| Example 3-17 | Compound Q | | | | 58 | 56 |
| Example 3-18 | Compound R | | | | 58 | 56 |
| Example 3-19 | Compound S | | | | 64 | 60 |
| Example 3-20 | Compound T | | | | 65 | 61 |
| Comparative | — | — | — | — | 55 | 48 |
| Example 3-1 | | | | | | |
| Example 3-21 | Compound A | 1 | Compound W | 10 | 78 | 74 |
| Example 3-22 | Compound B | | | | 78 | 75 |
| Example 3-23 | Compound C | | | | 77 | 75 |
| Example 3-24 | Compound D | | | | 76 | 73 |
| Example 3-25 | Compound E | | | | 75 | 72 |
| Example 3-26 | Compound F | | | | 76 | 72 |
| Example 3-27 | Compound G | | | | 75 | 71 |
| Example 3-28 | Compound H | | | | 76 | 72 |
| Example 3-29 | Compound I | | | | 74 | 70 |
| Example 3-30 | Compound J | | | | 82 | 80 |
| Example 3-31 | Compound K | | | | 83 | 81 |
| Example 3-32 | Compound L | | | | 83 | 81 |
| Example 3-33 | Compound M | | | | 81 | 80 |
| Example 3-34 | Compound N | | | | 81 | 80 |
| Example 3-35 | Compound O | | | | 80 | 78 |
| Example 3-36 | Compound P | | | | 80 | 77 |
| Example 3-37 | Compound Q | | | | 79 | 75 |
| Example 3-38 | Compound R | | | | 74 | 71 |
| Example 3-39 | Compound S | | | | 82 | 81 |
| Example 3-40 | Compound T | | | | 83 | 82 |
| Comparative | — | — | Compound W | 10 | 71 | 64 |
| Example 3-2 | | | | | | |

As can be seen in Table 3, Examples 3-1 to 3-20 containing the ether ester compound of formula (1) (compounds A to T) in the electrolytic solution had higher 300 cycle percentage remaining discharge capacity and charge load cycle percentage remaining discharge capacity than Comparative Example 3-1. The 300 cycle percentage remaining discharge capacity and the charge load cycle percentage remaining discharge capacity further improved in Examples 3-21 to 3-40 in which the halogenated cyclic carbonate ester (compound W) was contained in the electrolytic solution in addition to the ether ester compound of formula (1) (compounds A to T). The cycle percentage remaining discharge capacity and charge load cycle percentage remaining discharge capacity improved even more in Examples 3-30 to 3-34 and Examples 3-39 and 3-40, in which the electrolytic solution contained the halogenated ether ester compound (compounds J to N, S and T) and the halogenated cyclic carbonate ester (compound W). Specifically, in the electrolytic solution compositions that contained greater amounts of compound W (for example, 10 mass %), the effect of containing the halogenated ether ester compound (compounds J to N, S and T), similar in structure to compound W, was more prominent.

### Examples 4-1 to 4-20

The negative electrode was fabricated in the following manner. First, a cobalt powder and a tin powder was alloyed into a cobalt-tin powder, and dry-mixed with a carbon powder. The mixture (10 g) was then placed and set in the reaction chamber of a planetary ball mill (Ito Seisakusho Co., Ltd.) with steel balls (about 400 g; diameter, 9 mm). After creating an argon atmosphere in the reaction chamber, the mill was operated for a total of 20 hours by repeating 10 minutes of operation at 250 rpm and 10-minute rest. The reaction chamber was then cooled to room temperature, and, after removing the SnCoC-containing material, a coarse powder was removed through a 280-mesh sieve.

80 parts by mass of SnCoC-containing material (negative electrode active material), 8 parts by mass of the binder PVdF, 11 parts by mass of the conductive agent graphite, and 1 part by mass of acetylene black were uniformly mixed, and N-methylpyrrolidone was added to obtain a negative electrode mixture slurry. The negative electrode mixture slurry was then evenly coated over the both surfaces of a 15 μm copper foil (negative electrode collector), dried, and compression molded with a roller press machine to form a negative electrode active material layer. Thereafter, a nickel negative electrode lead was attached to one end of the negative electrode collector. For the rest of the procedure, the procedure of Examples 2-1 to 2-40 was followed to fabricate nonaqueous electrolyte batteries.

### Comparative Example 4-1

A nonaqueous electrolyte battery was fabricated in the same manner as in Example 4-1, except that compound A was not added for the preparation of the electrolytic solution.

### Comparative Example 4-2

A nonaqueous electrolyte battery was fabricated in the same manner as in Example 4-21, except that compound A was not added for the preparation of the electrolytic solution.

As in Example 1-1, the nonaqueous electrolyte batteries of Examples 4-1 to 4-40 and Comparative Examples 4-1 and 4-2 were evaluated by initial capacity and cycle test, and charge load cycle test. The test results are presented in Table 4.

TABLE 4

| | | | | | 300 Cycle | Charge load cycle |
|---|---|---|---|---|---|---|
| | | | | | percentage | percentage |
| | | | Cyclic carbonate | | remaining | remaining |
| | Ether ester compound | | ester compound | | discharge | discharge |
| | Type | Mass % | Type | Mass % | capacity [%] | capacity [%] |
| Example 4-1 | Compound A | 1 | — | — | 76 | 72 |
| Example 4-2 | Compound B | | | | 77 | 72 |
| Example 4-3 | Compound C | | | | 77 | 72 |
| Example 4-4 | Compound D | | | | 75 | 70 |
| Example 4-5 | Compound E | | | | 74 | 70 |
| Example 4-6 | Compound F | | | | 74 | 68 |
| Example 4-7 | Compound G | | | | 73 | 68 |
| Example 4-8 | Compound H | | | | 73 | 69 |
| Example 4-9 | Compound I | | | | 71 | 65 |
| Example 4-10 | Compound J | | | | 75 | 71 |
| Example 4-11 | Compound K | | | | 76 | 71 |
| Example 4-12 | Compound L | | | | 76 | 72 |
| Example 4-13 | Compound M | | | | 75 | 70 |
| Example 4-14 | Compound N | | | | 76 | 72 |
| Example 4-15 | Compound O | | | | 70 | 63 |
| Example 4-16 | Compound P | | | | 71 | 64 |
| Example 4-17 | Compound Q | | | | 72 | 64 |
| Example 4-18 | Compound R | | | | 71 | 67 |
| Example 4-19 | Compound S | | | | 76 | 71 |
| Example 4-20 | Compound T | | | | 75 | 72 |
| Comparative | — | — | — | — | 60 | 50 |
| Example 4-1 | | | | | | |
| Example 4-21 | Compound A | 1 | Compound W | 10 | 81 | 79 |
| Example 4-22 | Compound B | | | | 82 | 79 |
| Example 4-23 | Compound C | | | | 81 | 79 |
| Example 4-24 | Compound D | | | | 80 | 78 |
| Example 4-25 | Compound E | | | | 79 | 76 |
| Example 4-26 | Compound F | | | | 79 | 75 |
| Example 4-27 | Compound G | | | | 78 | 75 |
| Example 4-28 | Compound H | | | | 78 | 75 |
| Example 4-29 | Compound I | | | | 76 | 74 |
| Example 4-30 | Compound J | | | | 84 | 81 |
| Example 4-31 | Compound K | | | | 84 | 82 |
| Example 4-32 | Compound L | | | | 83 | 81 |
| Example 4-33 | Compound M | | | | 82 | 81 |
| Example 4-34 | Compound N | | | | 83 | 81 |
| Example 4-35 | Compound O | | | | 81 | 80 |
| Example 4-36 | Compound P | | | | 81 | 80 |
| Example 4-37 | Compound Q | | | | 81 | 79 |
| Example 4-38 | Compound R | | | | 77 | 72 |
| Example 4-39 | Compound S | | | | 83 | 81 |
| Example 4-40 | Compound T | | | | 83 | 82 |
| Comparative | — | — | Compound W | 10 | 68 | 61 |
| Example 4-2 | | | | | | |

As can be seen in Table 4, Examples 4-1 to 4-20 containing the ether ester compound of formula (1) (compounds A to T) in the electrolytic solution had higher 300 cycle percentage remaining discharge capacity and charge load cycle percentage remaining discharge capacity than Comparative Example 3-1. The 300 cycle percentage remaining discharge capacity and the charge load cycle percentage remaining discharge capacity further improved in Examples 4-21 to 4-40 in which the halogenated cyclic carbonate ester (compound W) was contained in the electrolytic solution in addition to the ether ester compound of formula (1) (compounds A to T). The cycle percentage remaining discharge capacity and charge load cycle percentage remaining discharge capacity improved even more in Examples 4-30 to 4-34 and Examples 4-39 and 4-40, in which the electrolytic solution contained the halogenated ether ester compound (compounds J to N, S and T) and the halogenated cyclic carbonate ester (compound W). Specifically, in the electrolytic solution compositions that contained greater amounts of compound W (for example, 10 mass %), the effect of containing the halogenated ether ester compound (compounds J to N, S and T), similar in structure to compound W, was more prominent.

### 4. Other Embodiments

While the present disclosure has been described with respect to certain embodiments and examples, the present disclosure is not limited by these embodiments and examples, and various modifications and applications are possible within the scope of the present disclosure. For example, while the foregoing Embodiments and Examples specifically described the nonaqueous electrolyte battery of a wound structure, the present disclosure is not limited to this specific example. For example, the present disclosure is also applicable to nonaqueous electrolyte batteries of other structures, including nonaqueous electrolyte batteries that have a folded battery element as a laminate of positive and negative electrodes, and nonaqueous electrolyte batteries that include a laminate of positive and negative electrodes. Further, even though the foregoing Embodiments and Examples were described through the use of a metal canister exterior member, other exterior members may be used. The exterior member may be rectangular, or may have a shape of a coin or a button. The nonaqueous electrolyte batteries according to the embodiments of the present disclosure can maintain desirable battery characteristics even in high-output applications, and thus can be preferably used as a power supply for high-output applications, including electrical power tools, and electric automobiles.

Further, even though the foregoing Embodiments and Examples were described through the use of lithium for the electrode reaction, the present disclosure is not limited to this. For example, the present disclosure is also applicable and equally effective even with other alkali metals such as sodium (Na) and potassium (K), alkali earth metals such as magnesium and calcium (Ca), and other light metals such as aluminum. Further, lithium metal may be used as the negative electrode active material.

The present disclosure contains subject matter related to that disclosed in Japanese Priority Patent Application JP 2010-211963 filed in the Japan Patent Office on Sep. 22, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A nonaqueous electrolyte comprising:
a solvent;
an electrolyte salt; and
an ether ester compound of the following formula (1): 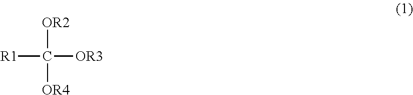
wherein R1 is a hydrogen group, an alkyl group, an aryl group, an alkoxy group, an ester group, or an acyl group, R2 to R4 are each independently an acyl group, a halogenated acyl group, an alkyl group, an aryl group, or a halogenated alkyl group, where at least one of R2 to R4 includes an acyl group or a halogenated acyl group.

2. The nonaqueous electrolyte of claim 1, wherein the ether ester compound of the formula (1) is an ether ester compound of the following formula (2): 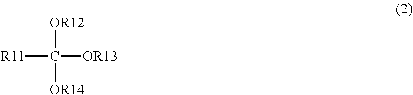
wherein R11 is a hydrogen group, an alkyl group, an aryl group, or an alkoxy group, where some of or all of the hydrogens may be substituted with halogens, R12 is an acyl group or a halogenated acyl group, R13 and R14 are each independently an alkyl group or an aryl group, where some of or all of the hydrogens may be substituted with halogens.

3. The nonaqueous electrolyte of claim 1, further comprising cyclic carbonate esters of the following formulae (3) and (4): 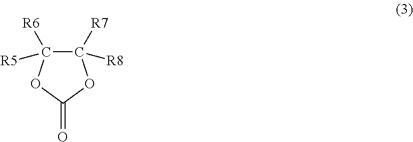
wherein R5 to R8 are each independently a hydrogen group, a halogen group, a vinyl group, an alkyl group, or a halogenated alkyl group, where at least one of R5 to R8 is a halogen group, a vinyl group, or a halogenated alkyl group, 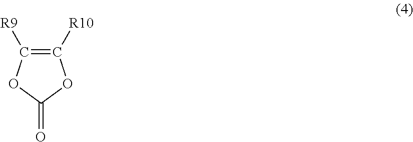
wherein R9 and R10 are each independently a hydrogen group, a halogen group, an alkyl group, or a halogenated alkyl group.

4. The nonaqueous electrolyte of claim 1, further comprising a halogenated cyclic carbonate ester of the following formula (5): 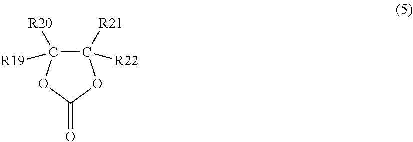
wherein R19 to R22 are each independently a hydrogen group, a halogen group, an alkyl group, or a halogenated alkyl group, where at least one of R19 to R22 is a halogen group or a halogenated alkyl group,
wherein the ether ester compound of the formula (1) is a halogenated ether ester compound of the following formula (7): 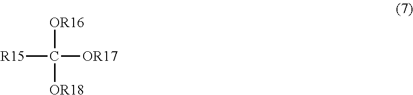
wherein R15 is a hydrogen group, an alkyl group, an aryl group, an alkoxy group, an ester group, or an acyl group, R16 to R18 are each independently an acyl group, a halogenated acyl group, an alkyl group, an aryl group, or a halogenated alkyl group, where at least one of R16 to R18 includes an acyl group or a halogenated acyl group, and where at least one of R16 to R18 includes a halogenated acyl group or a halogenated alkyl group.

5. The nonaqueous electrolyte of claim 1, wherein the content of the ether ester compound of the formula (1) ranges from 0.05 mass % to 5 mass %.

6. The nonaqueous electrolyte of claim 1, wherein the solvent contains a carbonate ester of the following formula (A):
R_{A}O—C(═O)—OR_{B},
where R_{A} and R_{B} each independently represent an alkyl group, and may be bonded to each other.

7. A nonaqueous electrolyte battery comprising:
a positive electrode;
a negative electrode; and
a nonaqueous electrolyte,
wherein the nonaqueous electrolyte includes a solvent, an electrolyte salt, and an ether ester compound of the following formula (1): 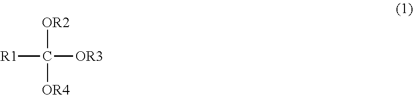
wherein R1 is a hydrogen group, an alkyl group, an aryl group, an alkoxy group, an ester group, or an acyl group, R2 to R4 are each independently an acyl group, a halogenated acyl group, an alkyl group, an aryl group, or a halogenated alkyl group, where at least one of R2 to R4 includes an acyl group or a halogenated acyl group.

8. The nonaqueous electrolyte battery of claim 7,
wherein the negative electrode includes at least one of silicon and tin as a negative electrode active material,
wherein the nonaqueous electrolyte further includes a halogenated cyclic carbonate ester of the following formula (5): 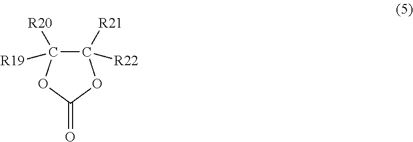
wherein R19 to R22 are each independently a hydrogen group, a halogen group, an alkyl group, or a halogenated alkyl group, where at least one of R19 to R22 is a halogen group or a halogenated alkyl group, and
wherein the ether ester compound of the formula (1) is a halogenated ether ester compound of the following formula (7): 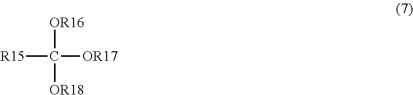
wherein R15 is a hydrogen group, an alkyl group, an aryl group, an alkoxy group, an ester group, or an acyl group, R16 to R18 are each independently an acyl group, a halogenated acyl group, an alkyl group, an aryl group, or a halogenated alkyl group, where at least one of R16 to R18 includes an acyl group or a halogenated acyl group, and where at least one of R16 to R18 includes a halogenated acyl group or a halogenated alkyl group.
